(19) United States
(12) Patent Application Publication
(10) Pub. No.: US 2023/0275223 A1
(43) Pub. Date: Aug. 31, 2023

(54) Active Cathode Material for Lithium-Ion Cells and Lithium-Ion Cell Having High Energy Density

(71) Applicant: Bayerische Motoren Werke Aktiengesellschaft, Muenchen (DE)

(72) Inventors: Sung-Jin KIM, Muenchen (DE); Hideki OGIHARA, Haimhausen (DE)

(21) Appl. No.: 18/009,065

(22) PCT Filed: May 5, 2021
(86) PCT No.: PCT/EP2021/061853

§ 371 Date: Dec. 8, 2022

(30) Foreign Application Priority Data
Jun. 9, 2020 (DE) 10 2020 115 222.1

(51) Int. Cl. H01M 4/505; H01M 10/0525; H01M 4/131; H01M 4/525; C01G 53/00

(52) U.S. Cl. CPC H01M 4/505; C01G 53/50; H01M 4/131; H01M 4/525; H01M 10/0525; C01P 2004/53; C01P 2006/40

(57) ABSTRACT

An active cathode material for a lithium-ion cell includes a mixture of particles having particle sizes distributed according to a bimodal particle size distribution which has a first modal value and a second modal value, where the first modal value is greater than the second modal value. The mixture of particles comprises first particles and second particles that intercalate lithium or are configured to intercalate lithium. The first particles have a particle size which is greater than a predefined first particle size range limit. The second particles have a particle size which is less than a predefined second particle size range limit. The second predefined particle size range limit is less than the predefined first particle size range limit. A particle size distribution of each of the first particles and the second particles is unimodal. The second particles have a mechanical strength higher than that of the first particles.

### BACKGROUND AND SUMMARY

The present disclosure relates to an active cathode material for a lithium-ion cell, to a process for producing the material, to a lithium-ion cell having a cathode comprising the active cathode material, and to a battery having such a lithium-ion cell.

Active cathode materials are used for producing cathodes of lithium-ion cells. In the process, the active cathode material is combined with a binder and, where appropriate, an electrical conductivity agent to form a thin paste (slurry). This paste is applied to a current collector made of aluminum, and is dried and pressed in the dried state using a calendering apparatus. Following the application of the paste to the current collector and the drying, there remain cavities between the particles of the active cathode material that are filled with binder and electrical conductivity agent. If the size of the particles of the active cathode material used is distributed unimodally, around a median value D50 of 12 µm and a span (D90-D10)/D50 of less than 1, for example, the volume fraction of the cavities per unit volume is high.

A high volume fraction of the cavities within the total volume of the cathode, however, is undesirable, as it negatively affects the specific capacity of the lithium-ion cell in which the active cathode material is used. To reduce the volume fraction of the cavities per unit volume, active cathode materials are used whose particles have a size distributed according to a bimodal distribution. An active cathode material of this kind is referred to below as a bimodal active cathode material. A bimodal distribution is shown in FIG. 2. It has two maxima (modes), one each at the particle sizes M1 and M2.

A bimodal active cathode material essentially has two groups of particles, which differ in their size: the group of the large particles, whose particle size is distributed around the modal value M1, and the group of the small particles, whose particle size is distributed around the modal value M2. The modal values M1 and M2 are selected such that the small particles find space in the cavities formed by the large particles. As a result, the density of the active cathode material is increased, and hence also the capacity of a lithium-ion cell which comprises a cathode formed of a bimodal active cathode material.

It has emerged, however, that in the pressing of the cathode material applied on the current collector, small particles may be crushed by large particles surrounding them or by the calender roll, and the group of the small particles may as a result crumble and/or break up to a considerable degree. This deformation is unwanted, especially when the particles of the active cathode material have been surface-coated in order, for example, to extend the life of the lithium-ion cell.

The object on which the present disclosure is based is therefore that of providing an improved bimodal active cathode material.

This object may be achieved in accordance with the teaching of independent claims 1 and 12. Various embodiments and developments of the technology are subjects of dependent claims 2 to 7.

A further object of the present disclosure is to provide a process for producing an improved bimodal active cathode material.

This object may be achieved in accordance with the teaching of independent claim 8. Various embodiments and developments of the technology are subjects of dependent claims 9 to 11.

A further object of the present disclosure is that of providing an improved lithium-ion cell.

This object may be achieved in accordance with the teaching of independent claim 13.

A first aspect of the disclosure relates to an active cathode material for a cathode of a lithium-ion cell, which comprises a mixture of particles whose particle sizes are distributed according to a bimodal particle size distribution with a first modal value and a second modal value;
where the first modal value is greater than the second modal value;
the mixture of particles comprises first particles and second particles which intercalate lithium or are configured to intercalate lithium;
the first particles are formed by the particles which have a particle size greater than a predefined first particle size range limit;
the second particles are formed by the particles which have a particle size smaller than a predefined second particle size range limit;
the second predefined particle size range limit is lower than the predefined first particle size range limit;
the particle size distribution of the first particles is unimodal and has a modal value which is equal to the first modal value;
the particle size distribution of the second particles is unimodal and has a modal value which is equal to the second model value;
the second particles may be crystalline and have a mechanical strength which is higher than the mechanical strength of the first particles. The mechanical strength of each of the second particles is preferably higher than the mechanical strength of any particle of the first particles. Also, preferably, the predefined first particle size range limit is lower than the first model value and/or the predefined second particle size range limit is greater than the second modal value.

As a result, during pressing of the cathode material applied to a current collector, it is possible to prevent the second (smaller) particles from being crushed by the first (larger) particles or by the calender roll, and hence to prevent fracturing of the second particles.

Mechanical strength in the sense of the present disclosure may refer to the mechanical resistance presented by a particle of the active cathode material to plastic deformation or separation. Particularly during the calendering of the active cathode material applied to a collector, a particle may exert, on another particle adjacent to it, a force which can lead to plastic deformation or fracture (crushing) of that particle. The mechanical resistance presented by a particle to such fracture may be considered to be the mechanical strength of that particle.

Particles in a powder which is suitable as active cathode material may adopt different geometrical shapes. However, particles in a powder - apart from powders in which the individual particles are fibers or needles - may be assumed to be spherical, and each particle may be assigned (or determined) an equivalent spherical diameter as the particle size. The particle size distribution, which quantifies the relative volume fraction of the particles according to their size, may be determined by laser diffraction.

In the sense of the present disclosure, the modal value is the designation for the particle size which occurs most frequently within a particle size distribution. If the particle size distribution is bimodal, it has two modal values (modes). These are in each case the particle sizes which correspond to the two peaks of the bimodal particle size distribution. The median value D50 is utilized when describing a unimodal particle size distribution, and corresponds to the particle size at 50% of the cumulative particle size distribution. In analogy, the D10 and D90 values correspond to the particle size at 10% and 90%, respectively, of the cumulative particle size distribution. The span (D90-D10)/D50 is utilized in order to describe the breadth of a unimodal distribution.

A cathode in the sense of the present disclosure is the electrode of a lithium-ion cell that has the higher potential in the lithium-ion cell; and the anode is the electrode of the lithium-ion cell that has the lower potential. Accordingly, the electrode comprises an active cathode material which has the higher potential in the lithium-ion cell.

The terms “encompasses”, “contains”, “includes”, “comprises”, “has”, “with”, or any other variant thereof, as used herein, are intended to cover a nonexclusive incorporation. Accordingly, for example, a process or a device which encompasses or comprises a list of elements is not necessarily restricted to these elements, but instead may include other elements which are not expressly recited or which are inherent to such a process or such a device.

Furthermore, “or”, unless the contrary is expressly indicated, relates to an inclusive or and not to an exclusive “or”. For example, a condition A or B is met by one of the following conditions: A is true (or present) and B is false (or not present), A is false (or not present) and B is true (or present), and both A and B are true (or present).

The terms “a/an” or “one”, as used herein, are defined in the sense of “one/one or more”. The terms “another” and “a further” and also any other variant thereof are to be understood in the sense of “at least one further”.

Described below are preferred embodiments of the disclosure, which in each case, unless expressly excluded or technically impossible, may be combined in any desired way with one another and also with the further described other aspects of the disclosure.

In one preferred embodiment, the second particles each have a core coated with a surface layer,
the surface layer gives the second particles a higher mechanical strength than that possessed by the first particles, and
the core intercalates lithium or is configured to intercalate lithium. The first surface layer preferably covers the entire surface of the core and its thickness is substantially uniform.

As a result, the second particles may comprise a higher mechanical strength than the first particles, and the second particles of the cathode material applied to a current collector are not crushed, during pressing, by the first particles or by the calender roll.

The core of the second particles and the first particles may comprise the same chemical substance, with the chemical substance intercalating lithium or being configured to intercalate lithium. The core of the second particles and the first particles may advantageously comprise Li₁(NiₓCo_{y}Mn_{z}Alᵣ)O₂ where (y+z+r) = (1-x); the surface layer may comprise one of the following substances: LiF, NH₄F, TiO₂, Al₂O₃, SnO₂, ZrO₂, ZnO, AlPO₄, Li₂TiO₃, Li₂ZrO₃; and the thickness of the surface layer surrounding the surface of the core may be less than 500 nm. x, y, z and r are real numbers. For example, x may be 0.8; y may be 0.1; z may be 0.1; and r may be zero.

In one preferred embodiment, the mechanical strength of the second particles is achieved through appropriate selection of one of the following or a combination thereof:
chemical substance of the surface layer,
thickness of the surface layer,
porosity of the surface layer.

As a result, the surface layer may be configured in order to give the second particles a mechanical strength which is higher than that of the second particles.

In one preferred embodiment, the second particles are each doped with a dopant which gives the second particles a higher mechanical strength than that possessed by the first particles.

As a result, the second particles may comprise a mechanical strength higher than that of the first particles, and the second particles of the cathode material applied to a current collector are, during pressing, not crushed by the first particles or by the calender roll.

Advantageously the first particles and the second particles comprise Li₁(NiₓCO_{y}Mn_{z}Alᵣ)O₂ where (y+z+r) = (1-x); and the dopant with which the second particles are doped is one of the following substances Al, Ti, Si, Mg, Nb, Mo, Fe, Cu, Cr, Zn.

In one preferred embodiment, the first particles have a first porosity and the second particles have a second porosity, and

the first porosity is greater than the second porosity.

As a result, the second particles may be given a higher mechanical strength than the first particles, and the second particles of the cathode material applied to a current collector are, during pressing, not crushed by the first particles or by the calender roll.

A particle of an active cathode material may itself be regarded as an agglomerate of multiple, mostly crystalline particles, referred to as primary particles. Between the primary particles, which are connected to one another, cavities may be formed and, as a result, the density (bulk density) of the composite particle (secondary particle) may be less than the density (true density) of a primary particle. The porosity of a secondary particle, expressed as a percentage, corresponds to the following formula: porosity[%] = [1-(bulk density/true density)] × 100.

Advantageously the first particles and the second particles comprise Li₁Ni_{0.8}Mn_{0.1}Co_{0.1}O₂. The first porosity is in a range between 4% and 40%, and the second porosity is in a range between 2% and 10%.

In one preferred embodiment, the particle size distribution of the first particles has a first full width at half-maximum;
the particle size distribution of the second particles has a second full width at half-maximum;
the predefined first particle size range limit is equal to the difference between the first modal value and half the first full width at half-maximum; and
the predefined second particle size range limit is equal to the sum total between the second modal value and half the second full width at half-maximum.

As a result it is possible to ensure that the majority of the particles whose particle size is distributed around the second modal value have a higher mechanical strength than the majority of the particles whose particle size is distributed around the first modal value.

In one preferred embodiment, the first modal value is in a range between 7 µm and 14 µm, and the second modal value is in a range between 1 µm and 6 µm. Preferably the first modal value is in a range between 10 µm and 13 µm, and the second modal value is in a range between 2 µm and 4 µm.

As a result, the second particles are able to find space in the cavities formed by the first particles. This increases the density of the active cathode material, and a lithium-ion cell which comprises a cathode formed of the active cathode material has a high specific capacity/energy density.

The first full width at half-maximum is situated, for example, in a range between 1 µm and 4 µm, and the second full width at half-maximum, for example, in a range between 1 µm and 4 µm.

A second aspect of the disclosure relates to a process for producing an active cathode material for a lithium-ion cell, comprising:
providing a first powder which has first particles whose particle size is distributed according to a first particle size distribution and which intercalate lithium or are configured to intercalate lithium,
where the median value D50 of the first particle size distribution is in a range between 7 µm and 14 µm and the span of the first particle size distribution is less than 1;
providing a second powder which has second particles whose particle size is distributed according to a second particle size distribution and which intercalate lithium or are configured to intercalate lithium,
where the median value D50 of the second particle size distribution is in a range between 1 µm and 6 µm, the span of the second particle size distribution is less than 1, and the second particles have a higher mechanical strength than the first particles; and
mixing the first powder and the second powder to give a mixture which has a bimodal particle distribution. Preferably the mechanical strength of each of the second particles is higher than the mechanical strength of any particle of the first particles. The first particle size distribution and/or the second particle size distribution may be Gaussian. Preferably the median value D50 of the first particle size distribution is in a range between 10 µm and 13 µm, and the median value D50 of the second particle size distribution is in a range between 2 µm and 4 µm.

As a result, a process may be provided with which an improved bimodal active cathode material can be produced. The advantages elucidated in respect of the first aspect of the disclosure are also valid correspondingly for the active cathode material produced by the process of the disclosure.

In one preferred embodiment, the providing of the second powder further comprises:

Coating the second particles with a surface layer which gives the coated second particles a higher mechanical strength than that possessed by the first particles. During coating, preferably, the entire surface of the second particles is coated, and the thickness of the coating is substantially uniform.

As a result, it is possible to produce a bimodal active cathode material whose second particles have a higher mechanical strength than the first particles. During the pressing of the cathode material, as a result, the second particles are not crushed by the first particles or by the calender roll.

The particles of the first powder and of the second powder advantageously comprise Li₁(NiₓCo_{y}Mn_{z}Alᵣ)O₂ where (y+z+r) = (1-x); the surface layer of the coated second particles comprises one of the following substances: LiF, NH₄F, TiO₂, Al₂O₃, SnO₂, ZrO₂, ZnO, AlPO₄, Li₂TiO₃, Li₂ZrO₃; and the thickness of the surface layer is less than 500 nm.

In one preferred embodiment, the providing of the second powder further comprises:

Doping the second particles with a dopant which gives the second particles a higher mechanical strength than that possessed by the first particles.

As a result, it is possible to produce a bimodal active cathode material whose second particles have a higher mechanical strength than the first particles. During the pressing of the cathode material, as a result, the second particles are not crushed by the first particles or by the calender roll.

The particles of the first powder and of the second powder advantageously comprise Li₁(NiₓCo_{y}Mn_{z}Alᵣ)O₂ where (y+z+r) = (1-x); and the dopant with which the second particles are doped is one of the following substances: Al, Ti, Si, Mg, Nb, Mo, Fe, Cu, Cr, Zn.

In one preferred embodiment, the first particles have a first porosity and the second particles have a second porosity, and

The first porosity is greater than the second porosity.

As a result, it is possible to produce a bimodal active cathode material whose second particles have a higher mechanical strength than the first particles. During the pressing of the cathode material, as a result, the second particles are not crushed by the first particles or by the calender roll.

The particles of the first powder and of the second powder advantageously comprise Li₁Ni_{0.8}Mn_{0.1}Co_{0.1}O₂; the first porosity is in a range between 4% and 40%, and the second porosity is in a range between 2% and 10%.

A third aspect of the disclosure relates to an active cathode material produced by the processes of the disclosure.

The advantages elucidated in respect of the first aspect of the disclosure may also be valid correspondingly for its third aspect.

A fourth aspect of the disclosure relates to a lithium-ion cell comprising: a first electrode, a second electrode, and a separator separating the first electrode and the second electrode, where the first electrode has a higher potential than the second electrode, and

The first electrode comprises a binder-bound, pressed active cathode material of the disclosure.

As a result, a lithium-ion cell with high capacity (energy density) may be provided. The life of the battery may also be prolonged.

A fifth aspect of the disclosure relates to a battery comprising a lithium-ion cell of the disclosure.

As a result, a battery with high capacity may be provided. Its life may also be prolonged.

A sixth aspect of the disclosure relates to a vehicle comprising a battery of the disclosure.

As a result, the range of a vehicle with electrical drive can be extended.

Further advantages, features, and possible applications of the present invention are apparent from the detailed description below in connection with the figures.

### BRIEF DESCRIPTION OF THE DRAWINGS

FIG. 1 shows schematically an active cathode material for a lithium-ion cell according to the present disclosure;

FIG. 2 shows schematically a bimodal particle size distribution;

FIG. 3 shows schematically a second (small) particle of an active cathode material according to one embodiment;

FIG. 4 shows schematically the internal structure of a particle of an active cathode material;

FIG. 5 shows schematically one process of the disclosure for producing an active cathode material for a lithium-ion cell; and

FIG. 6 shows schematically another process of the disclosure for producing an active cathode material for a lithium-ion cell.

The figures consistently use the same reference symbols for the same or mutually corresponding elements.

### DETAILED DESCRIPTION OF THE DRAWINGS

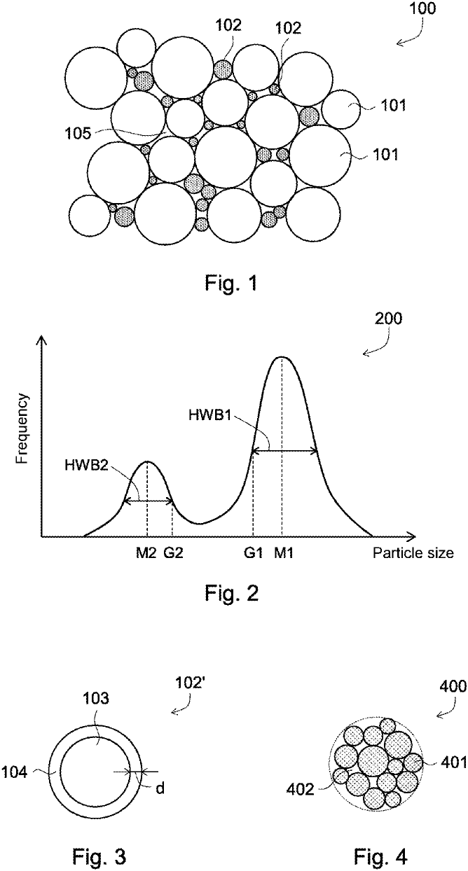

FIG. 1 shows schematically an active cathode material for a lithium-ion cell according to the present disclosure. This material comprises a mixture 100 of particles 101 and 102, whose respective particle sizes are distributed according to a bimodal particle size distribution 200 and which intercalate lithium or are configured to intercalate lithium.

The bimodal particle size distribution 200 is shown schematically in FIG. 2. It has two peaks with respective modal values M1 and M2. The first modal value M1 represents the particle size at which the first peak (the right-hand peak in FIG. 2) reaches its maximum; and the second modal value M2 represents the particle size at which the second peak (the lefthand peak) reaches its maximum. The first modal value M1 is greater than the second modal value M2; M1 > M2. The width of the first and second peaks may each be indicated by the full width at half-maximum HWB1 and HWB2 respectively. The first full width at half-maximum HWB1 represents the difference between the two particle sizes, for which the frequency of the particle sizes distributed around the first peak has dropped to half of its maximum; and the full width at half-maximum HWB2 represents the difference between the two particle sizes, for which the frequency of the particle sizes distributed around the second peak has dropped to half of its maximum.

First particles (or large particles) of the mixture 100 are, hereinafter, all particles having a particle size which is greater than a predefined first particle size range G1; and second particles (or small particles) of the mixture 100, hereinafter, are all particles which have a particle size less than a predefined second particle size range limit G2. The second particle size range limit G2 is less than the first particle size range limit G1; G2 < G1. The particle size distribution of the first particles is unimodal and as a modal value has the first modal value M1 of the bimodal distribution 200 and the particle size distribution of the second particles is unimodal and has a modal value of the second modal value M2 of the bimodal distribution 200. Advantageously, as shown in FIG. 2, the first particle size range limit is less than the first modal value; G1 < M1; and the second particle size range limit is greater than the second modal value; G2 > M2. For example, the predefined first particle size range limit may be equal to the difference between the first modal value and half the first full width at half-maximum; G1 = M1-HWB1/2; and the predefined second particle size range limit may be equal to the sum total between the second modal value and half the second full width at half-maximum; G2 = M2+HWB2/2.

The modal values M1 and M2 and also the full widths at half-maximum HWB1 and HWB2 are advantageously selected such that the second particles find space, and are disposed in, the cavities 105 formed by the first particles. This is the case, for example, when the first modal value M1 is in a range between 7 µm and 14 µm, the first full width at half-maximum HWB1 is in a range between 1 µm and 4 µm, the second modal value M2 is in a range between 1 µm and 6 µm, and the second full width at half-maximum HWB2 is in a range between 1 µm and 4 µm. This allows the density of the active cathode material to be increased.

In accordance with the disclosure, the second particles are crystalline and each second (small) particle has a mechanical strength which is higher than the mechanical strength of any first (large) particle. As a result, during the calendering (pressing) of a cathode material which is applied to a current collector and which contains the active cathode material 100, the small particles are not crushed by the large particles or by the calender roll; and a lithium-ion cell which contains a cathode comprising the active cathode material 100 is substantially improved.

A higher mechanical strength can be given to a second particle by a surface layer which overlies the second particle and is configured correspondingly. FIG. 3 shows schematically a second particle 102′, which comprises a core 103 coated with a surface layer 104, where the surface layer 104 surrounds the entire surface of the core 103, the thickness d of the surface layer 104 is substantially constant, and the core 103 intercalates lithium or is configured to intercalate lithium. The surface layer 104 is configured such that it gives the second particle 102′ a higher mechanical strength than that possessed by any first particle 101. This may be achieved through appropriate selection of one or more of the following parameters: chemical substance of the surface layer 104, thickness of the surface layer 104, porosity of the surface layer 104. The surface layer 104 need not cover the entire surface of the core 104 in order to give the respective second particle a higher strength.

The active cathode material 100 advantageously comprises first particles 101 and second particles 102′; where the core 103 of the second particles 102′ and the first particles 101 each comprise the chemical substance Li₁(NiₓCo_{y}Mn_{z}Alᵣ)O₂ where (y+z+r) = (1-x); the surface layer 104 comprises one of the following chemical substances: LiF, NH₄F, TiO₂, Al₂O₃, SnO₂, ZrO₂, ZnO, AlPO₄, Li₂TiO₃, Li₂ZrO₃; and the thickness of the surface layer surrounding the surface of the core 103 is less than 500 nm.

A higher mechanical strength may also be given to a second particle by a suitable dopant with which the particle is doped. The second particles 102 of the active cathode material 100 may therefore be doped with a dopant which gives each second particle 102 a higher mechanical strength than that possessed by any first particle 101.

The active cathode material 100 advantageously comprises first particles and second particles, where the first particles and the second particles each comprise the chemical substance Li₁(NiₓCo_{y}Mn_{z}Alᵣ)O₂ where (y+z+r) = (1-x), and the second particles are doped with one of the following dopants: Al, Ti, Si, Mg, Nb, Mo, Fe, Cu, Cr, Zn.

A higher mechanical strength may also be given to a second particle by a suitably configured porosity of the second particle. FIG. 4 shows schematically a particle 400 of the active cathode material 100. This may be a first or second particle. The particle 400 comprises one or more, usually crystalline subparticles 401 (which are also referred to as primary particles), which are connected to one another and between which there may be cavities 402. As a result, the density (bulk density) of the particle 400 (which is also referred to as secondary particle) can be less than the density (true or crystallographic density) of a primary particle 401. The porosity of a particle, expressed as a percentage below, corresponds to the following formula:

$$\text{Porosity[\%] = [1-(bulk density/true density)]} \times \text{100}$$

In the active cathode material 100, the first particles may have a higher porosity than the second particles. In that case the porosity of the first particles and/or of the second particles is such that each second particle 102 has a higher mechanical strength than any first particle.

The active cathode material 100 advantageously comprises first particles and second particles, where the first particles 101 and the second particles 102 each comprise the chemical substance Li₁Ni_{0.8}Mn_{0.1}Co_{0.1}O₂, the porosity of a first particle is in a range between 4% and 40%, and the porosity of a second particle is in a range between 2% and 10%.

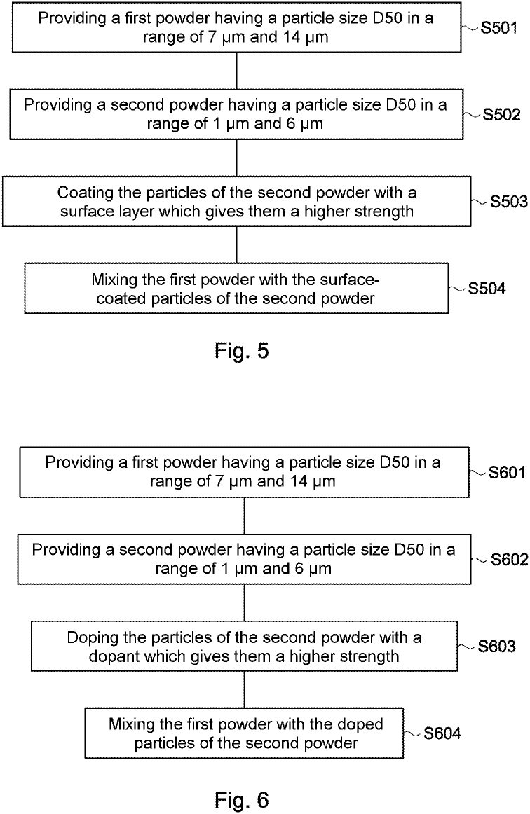

FIG. 5 shows schematically one process of the disclosure for producing an active cathode material for a lithium-ion cell.

In a step S501 a first powder is provided, comprising first particles whose particle size is distributed according to a first particle size distribution, and which intercalate lithium or are configured to intercalate lithium. The first particle size distribution is preferably unimodal, has a median value D50 which is in a range between 7 µm and 14 µm, and has a span which is less than one. The median value D50 of the first particle size distribution is preferably in a range between 10 µm and 13 µm.

In a step S502, a second powder is provided, which comprises second particles, yet to be coated, whose particle size is distributed according to a second particle size distribution, and which intercalate lithium or are configured to intercalate lithium. The second particle size distribution is preferably unimodal. The second particles, yet to be coated, may be uncoated particles each formed of only one or of two or more primary particles. The second particles yet to be coated may alternatively be particles which are already surface-coated.

In a step S503, the second particles yet to be coated are coated with a surface layer which surrounds their surface at least partly, preferably entirely. During coating, the surface layer is configured such that it gives the second particle coated with it a mechanical strength which is higher than that of any particle of the first powder. More particularly, this may be achieved through suitable selection of one or more of the following parameters of the surface layer: chemical substance, thickness, and/or porosity. After coating, the particle size of the second particles (coated with the surface layer) is distributed according to a unimodal distribution corresponding to the second particle size distribution. This distribution has a median value D50 which is in a range between 1 µm and 6 µm and a span which is less than one. The median value D50 is preferably in a range between 2 µm and 4 µm.

The coating may take place by wet-chemical treatment of the second particles for coating, in a solution which contains the chemical substance of the surface layer to be formed. Coating may also be achieved by mixing the second powder together with a powder which contains the chemical substance of the surface layer to be formed, and then carrying out calcining.

In a step S504, the first powder is mixed with the second powder surface-coated in step S503.

Advantageously, the particles of the first powder and the yet-to-be-coated particles of the second powder each comprise Li₁(NiₓCo_{y}Mn_{z}Alᵣ)O₂ where (y+z+r) = (1-x); and, after coating, the second particles each have a surface layer which contains one of the following chemical substances: LiF, NH₄F, TiO₂, Al₂O₃, SnO₂, ZrO₂, ZnO, AlPO₄, Li₂TiO₃, Li₂ZrO₃; and the surface layer has a layer thickness of less than 500 nm.

FIG. 6 shows schematically another process of the disclosure for producing an active cathode material for a lithium-ion cell.

In a step S601 a first powder is provided, comprising first particles whose particle size is distributed according to a first particle size distribution, and which intercalate lithium or are configured to intercalate lithium. The first particle size distribution is preferably unimodal, has a median value D50 which is in a range between 7 µm and 14 µm, and has a span which is less than one. The median value D50 of the first particle size distribution is preferably in a range between 10 µm and 13 µm.

In a step S602, a second powder is provided, which comprises second particles, yet to be doped, whose particle size is distributed according to a second particle size distribution, and which intercalate lithium or are configured to intercalate lithium. The second particle size distribution is preferably unimodal, has a median value D50 which is in a range between 1 µm and 6 µm, and has a span which is less than one. The median value D50 of the second particle size distribution is preferably in a range between 2 µm and 4 µm.

In a step S603, the second particles, still to be doped, are doped with a dopant which gives the second particles doped with the dopant a mechanical strength which is higher than that of any particle of the first powder.

In a step S604, the first powder is mixed with the second powder doped in step S603.

Advantageously, the particles of the first powder and the yet-to-be-doped particles of the second powder each comprise Li₁(NiₓCo_{y}Mn_{z}Alᵣ)O₂ where (y+z+r) = (1-x); and the dopant with which the particles of the second powder are doped is one of the following substances: Al, Ti, Si, Mg, Nb, Mo, Fe, Cu, Cr, Zn.

Whereas the preceding text has described at least one illustrative embodiment, it should be noted that a large number of variations thereon exist. It should also be borne in mind here that the illustrative embodiments described only represent nonlimiting examples, and there is no intention thereby to restrict the scope, the applicability or the configuration of the devices and processes described here. Instead, the description above will give the skilled person instructions regarding the implementation of at least one illustrative embodiment, on the understanding that various changes may be made in the functioning and the arrangement of the elements described in an illustrative embodiment, without departure from the subject matter laid down in each of the appended claims, or from the legal equivalents of that subject matter.

LIST OF REFERENCE NUMERALS

| | |
|---|---|
| 100 | Active cathode material |
| 101 | First (large) particles |
| 102, 102′ | Second (small) particles |
| 103 | Core of a second particle |
| 104 | Surface layer of a second particle |
| 105 | Cavities |
| 200 | Bimodal particle size distribution |
| 400 | Particles of an active cathode material (secondary particles) |
| 401 | Primary particles |
| 402 | Cavities between primary particles |

1-15. (canceled)

16. An active cathode material for a lithium-ion cell, the active cathode material comprising:
a mixture of particles having particle sizes distributed according to a bimodal particle size distribution with a first modal value (M1) and a second modal value (M2), the first modal value (M1) being greater than the second modal value (M2), the mixture of particles comprising first particles and second particles which intercalate lithium or are configured to intercalate lithium, wherein
the first particles have a particle size greater than a predefined first particle size range limit (G1),
the second particles have a particle size smaller than a predefined second particle size range limit (G2),
the second predefined particle size range limit (G2) is lower than the predefined first particle size range limit (G1),
a particle size distribution of the first particles is unimodal and has a modal value equal to the first modal value (M1),
a particle size distribution of the second particles is unimodal and has a modal value equal to the second model value (M2),
the second particles have a mechanical strength higher than a mechanical strength of the first particles.

17. The active cathode material according to claim 16, wherein the second particles each have a core coated with a surface layer, and wherein
the surface layer gives the second particles the mechanical strength higher than the mechanical strength of the first particles, and
the core intercalates lithium or is configured to intercalate lithium.

18. The active cathode material according to claim 17, wherein the mechanical strength of the second particles is achieved through appropriate selection of one of the following or a combination thereof:
chemical substance of the surface layer,
thickness of the surface layer,
porosity of the surface layer.

19. The active cathode material according to claim 16, wherein the second particles are each doped with a dopant which gives the second particles the mechanical strength higher than the mechanical strength of the first particles.

20. The active cathode material according to claim 16, wherein
the first particles have a first porosity and the second particles have a second porosity, and
the first porosity is greater than the second porosity.

21. The active cathode material according to claim 16, wherein
the particle size distribution of the first particles has a first full width at half-maximum (HWB1);
the particle size distribution of the second particles has a second full width at half-maximum (HWB2);
the predefined first particle size range limit (G1) is equal to a difference between the first modal value (M1) and half the first full width at half-maximum (HWB1); and
the predefined second particle size range limit (G2) is equal to a sum total between the second modal value (M2) and half the second full width at half-maximum (HWB2).

22. The active cathode material according to claim 21, wherein
the first modal value (M1) is in a range between 7 µm and 14 µm, and
the second modal value (M2) is in a range between 1 µm and 6 µm.

23. A process for producing an active cathode material for a lithium-ion cell, the process comprising:
providing a first powder comprising first particles having a particle size distributed according to a first particle size distribution, the first particles intercalating lithium or being configured to intercalate lithium, wherein a median value D50 of the first particle size distribution is in a range between 7 µm and 14 µm and a span of the first particle size distribution is less than 1;
providing a second powder comprising second particles having a particle size distributed according to a second particle size distribution, the second particles intercalating lithium or being configured to intercalate lithium, wherein a median value D50 of the second particle size distribution is in a range between 1 µm and 6 µm, a span of the second particle size distribution is less than 1, and the second particles have a mechanical strength higher than a mechanical strength of the first particles; and
mixing the first powder and the second powder to give a mixture having a bimodal particle distribution.

24. The process according to claim 23, wherein the providing of the second powder further comprises:
coating the second particles with a surface layer, whereby the second particles have the mechanical strength higher than the mechanical strength of the first particles.

25. The process according to claim 23, wherein the providing of the second powder further comprises:
doping the second particles with a dopant, whereby the second particles have the mechanical strength higher than the mechanical strength of the first particles.

26. The process according to claim 23, wherein
the first particles have a first porosity and the second particles have a second porosity, and
the first porosity is greater than the second porosity.

27. An active cathode material produced by the process according to claim 23.

28. A lithium-ion cell, comprising:
a first electrode;
a second electrode; and
a separator separating the first electrode and the second electrode, wherein
the first electrode has a higher potential than the second electrode, and
the first electrode has a binder-bound, pressed active cathode material according to claim 1.

29. A battery comprising a lithium-ion cell according to claim 28.

30. A vehicle comprising a battery according to claim 29.
